(19) United States
(12) Patent Application Publication
(10) Pub. No.: US 2018/0335227 A1
(43) Pub. Date: Nov. 22, 2018

(54) UNIVERSAL REMOTE MOUNT DAMPER LINKAGE

(71) Applicant: Johnson Controls Technology Company, Plymouth, MI (US)

(72) Inventor: Russell T. Jenks, Racine, WI (US)

(73) Assignee: Johnson Controls Technology Company, Plymouth, MI (US)

(21) Appl. No.: 15/599,046

(22) Filed: May 18, 2017

(51) Int. Cl. F24F 13/10; F16C 11/06; F16C 3/28; F16K 31/52

(52) U.S. Cl. CPC F24F 13/10; F16K 31/52; F16C 3/28; F16C 11/06

(57) ABSTRACT

A remote mount kit for a damper in an HVAC system is provided. The remote mount kit includes a mounting bracket. The mounting bracket includes a first mounting flange having a first mounting hole pattern and a second mounting flange having a second mounting hole pattern. The remote kit also includes a drive shaft having a first drive end and a second drive end. The first drive end and the second drive end are configured to couple to an actuator. The remote kit further includes a crank shaft and a connector configured to couple the crank shaft to the damper. A dimension between the holes of the first mounting hole pattern is smaller than a dimension between the holes of the second mounting hole pattern.

### BACKGROUND

The present disclosure relates generally to the field of accessories for HVAC components. The present disclosure relates more particularly to a universal remote mount linkage for a damper.

In an HVAC system, a flow control unit such as a variable air volume box or an air handling unit may include a damper for regulating the rate of gas or fluid flow. The damper may variably open and close to adjust the flow rate of a controlled gas or fluid (e.g., air) through the flow control unit. Often the opening and closing of the damper is accomplished by an actuator. Although many dampers include a damper shaft that is directly linked to the actuator and a damper blade, in some instances, this direct linkage is not possible due to size constraints or a lack of compatibility between the mounting interfaces of the actuator and the damper.

### SUMMARY OF THE INVENTION

One embodiment of the present disclosure relates to a remote mount kit for a damper in an HVAC system. The remote mount kit includes a mounting bracket. The mounting bracket includes a first mounting flange having a first mounting hole pattern and a second mounting flange having a second mounting hole pattern. The remote kit also includes a drive shaft having a first drive end and a second drive end. The first drive end and the second drive end are configured to couple to an actuator. The remote kit further includes a crank shaft and a connector configured to couple the crank shaft to the damper. A dimension between the holes of the first mounting hole pattern is smaller than a dimension between the holes of the second mounting hole pattern.

In some embodiments, the mounting bracket includes at least one bracket mounting flange configured to couple the remote mount kit to a mounting surface. In other embodiments, the mounting surface is an interior surface of an air duct.

In some embodiments, the connector is a ball and socket connector.

In some embodiments, both the first drive end and the second drive end have a substantially square shape. In other embodiments, the width of the first drive end is smaller than the width of the second drive end.

In some embodiments, the drive shaft includes a knurled portion between the first drive end and the second drive end.

In some embodiments, the crank shaft further includes a slot and the connector is configured to couple to the slot.

In some embodiments, the drive shaft is configured to protrude through the first mounting flange and the second mounting flange.

Another implementation of the present disclosure is a system for coupling an actuator to a damper. The system includes an actuator with a drive mechanism, a damper including a damper blade movable between an open position and a closed position, and a remote mount kit. The remote mount kit includes a mounting bracket having a first mounting hole pattern and a second mounting hole pattern, a drive shaft, a crank shaft, and a connector. The remote mount kit is configured to couple the drive mechanism of the actuator to the damper to drive the damper between the open position and the closed position.

In some embodiments, the drive shaft has a first drive end and a second drive end, and at least one of the first end and the second end is configured to couple to the drive mechanism of the actuator. In other embodiments, both the first drive end and the second drive end have a substantially square shape. In other embodiments, the width of the first drive end is smaller than the width of the second drive end.

In some embodiments, the drive shaft further comprises a knurled portion between the first drive end and the second drive end.

In some embodiments, both the first mounting hole pattern and the second mounting hole pattern have a square shape. In other embodiments, the width of the first mounting hole pattern is smaller than the width of the second mounting hole pattern.

In some embodiments, the connector is a ball and socket connector.

Another implementation of the present disclosure is a universal remote mount kit to couple an actuator to a damper in an HVAC system. The universal remote mount kit includes a mounting bracket. The mounting bracket includes a first actuator mounting flange having holes in a first square pattern. The universal remote mount kit also includes a drive shaft configured to couple to a drive mechanism of an actuator. The drive shaft includes a first end having a substantially square shape configured to protrude through the first actuator mounting flange. The universal remote mount kit further includes a crank shaft coupled to the drive shaft. The crank shaft includes a slot and a damper connector is configured to couple to the slot of the crank shaft.

In some embodiments, the mounting bracket also includes a bracket mounting flange configured to couple the universal remote mount kit to an interior surface of an air duct.

In some embodiments, the mounting bracket further includes a second actuator mounting flange having holes in a second square pattern, the drive shaft further includes a second end having a substantially square shape configured to protrude through the second actuator mounting flange, and the width of the first square pattern is smaller than the width of the second square pattern.

### BRIEF DESCRIPTION OF THE DRAWINGS

FIG. 1 is a perspective view of a universal remote mount kit, according to some embodiments.

FIG. 2 is another perspective view of the universal remote mount kit of FIG. 1, according to some embodiments.

FIG. 3 is a side elevation view of the universal remote mount kit of FIG. 1, according to some embodiments.

FIG. 4 is a perspective view of a universal remote mount assembly, according to some embodiments.

### DETAILED DESCRIPTION

Before turning to the FIGURES, which illustrate the exemplary embodiments in detail, it should be understood that the disclosure is not limited to the details or methodology set forth in the description or illustrated in the figures. It should also be understood that the terminology is for the purpose of description only and should not be regarded as limiting.

Referring generally to the FIGURES, a universal remote mount kit for a damper in an HVAC system is shown, according to some embodiments. The damper may be attached to an actuator that is utilized to drive the damper between an open position and a closed position. By variably opening and closing, the damper may regulate the flow rate (e.g., volumetric flow rate, flow velocity, mass flow rate) through a flow control unit such as a variable air volume box or an air handling unit. When space permits and the interface between the damper and the actuator is compatible, a linkage arm of the damper may be directly driven by the actuator without the use of any intermediary devices or components. However, in certain instances, for example when there is not sufficient space to mount the actuator proximate to the damper, or in a retrofit application where the damper and actuator interfaces are not compatible, the actuator may be remotely mounted from the damper. In these instances, it is useful to provide a remote mount kit that links the drive mechanism of the actuator to the damper.

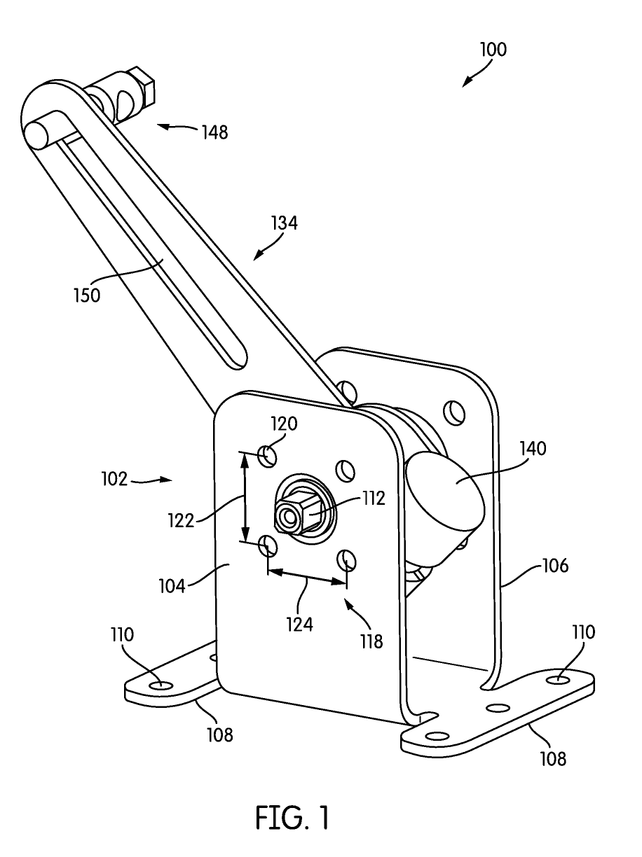

Thus, systems and methods described below provide a kit that links the actuator to the damper and permits the actuator to be remotely mounted from the damper in some embodiments. Previous solutions to the remote mount kit are generally customized to the particular characteristics (e.g., model number, series number, style) of the actuator and the damper. However, this customization significantly increases the cost of the remote mount kit, due to design costs, tooling costs, and the low volume of parts involved. Thus, some embodiments of the remote mount kit described below with reference to FIGS. 1-4 are designed to utilize the mounting interface already included on many HVAC actuators to couple the actuator to a drive shaft and linkage or crank arm. The crank arm couples to a damper connector such that when the drive shaft and the crank arm rotate due to the drive mechanism of the actuator, the damper is also driven between its open position and closed position. To make the make the remote mount kit as widely usable as possible, the remote mount kit includes actuator interfaces of multiple sizes, and the remote mount kit itself is able to be both assembled and mounted in multiple orientations.

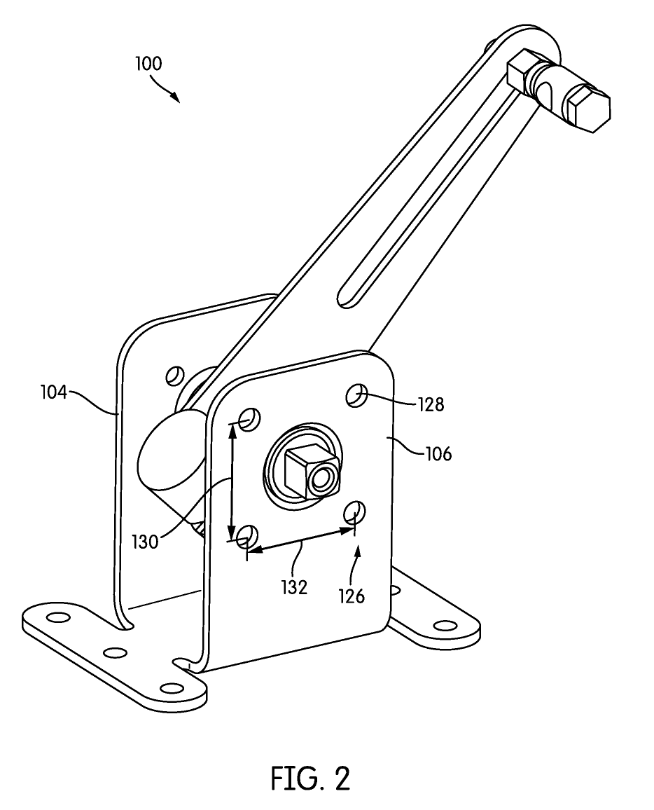

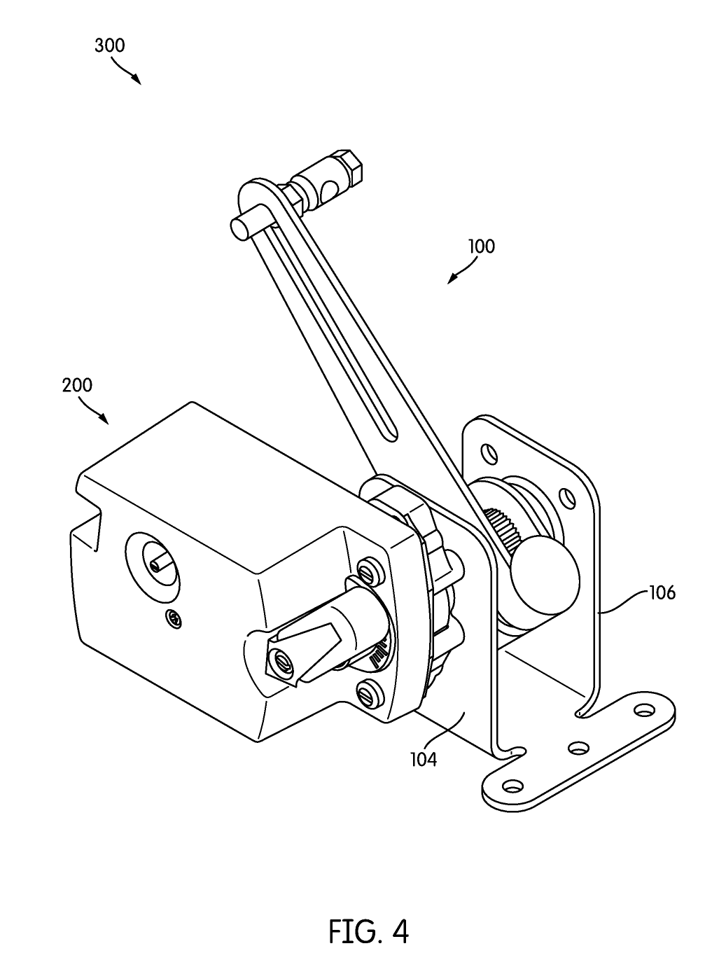

Referring to FIGS. 1-3, views of a universal remote mount kit 100 are depicted, according to some embodiments. Referring specifically to FIGS. 1-2, the universal remote mount kit 100 is shown to include, among other components, a mounting bracket 102, a drive shaft 112, a crank arm 134, a coupling bolt 140, and a ball socket connector 148. Mounting bracket 102 may be configured to couple to an actuator 200 (described below with reference to FIG. 4). In some embodiments, mounting bracket 102 includes a first actuator mounting flange 104 and a second actuator mounting flange 106.

First actuator mounting flange 104 is shown to include a first actuator mounting hole pattern 118, while second actuator mounting flange 106 is shown to include a second actuator mounting hole pattern 126. In some embodiments, both the first actuator mounting flange 104 and the second actuator mounting flange 106 may be configured to receive mounting features (e.g., posts) included on the mounting interface of the actuator. For example, in some embodiments, the mounting features may be anti-rotation posts that are normally utilized when mounting an actuator to a ball valve (e.g., the VG1000 series ball valve sold by Johnson Controls, Inc.). In other embodiments, only one side of mounting bracket 102 is configured to couple to an actuator (e.g., via first actuator mounting hole pattern 118), and thus second actuator mounting hole pattern 126 may be omitted from mounting bracket 102.

In various embodiments, first actuator mounting hole pattern 118 has different dimensions from second actuator mounting hole pattern 126. This may be because first actuator mounting hole pattern 118 may be intended to accommodate an actuator with a smaller mounting interface than the actuator accommodated by second actuator mounting hole pattern 126. For example, in some embodiments, first actuator mounting hole pattern 118 includes mounting holes 120 in a 36 mm diameter mounting bolt circle, while second actuator mounting hole pattern 126 includes mounting holes 128 in a 50 mm diameter mounting bolt circle. In other words, first actuator mounting pattern height 122 is smaller than second actuator mounting pattern height 130, and first actuator mounting pattern width 124 is smaller than second actuator mounting pattern width 132. Although the mounting patterns 118 and 126 of FIGS. 1-2 are square (i.e., first actuator pattern height 122 is equal to pattern width 124, and second actuator pattern height 130 is equal to pattern width 132), mounting patterns 118 and 126 may be any pattern required to couple to the mounting features of the actuator intended to drive the damper.

As shown in FIGS. 1-2, first actuator mounting hole pattern 118 and second actuator mounting hole pattern 126 each include four mounting holes 120 and 128. In other embodiments, hole patterns 118 and 126 may include any number of mounting holes 120 and 128 required to accommodate an actuator mounting interface. In addition, the diameters of mounting holes 120 and 128 may be any size required to receive mounting features of the actuator.

In various embodiments, mounting bracket 102 additionally includes at least one mounting bracket mounting flange 108. For example, as shown in FIGS. 1-2, mounting bracket 102 may include a mounting flange 108 at each end of the first actuator mounting flange 104 and the second actuator mounting flange 106. In various embodiments, each mounting flange 108 includes at least one mounting bracket mounting hole 110. For example, as shown in FIGS. 1-2, each mounting flange 108 includes three mounting holes 110. However, in other embodiments, mounting flange 108 includes any number of mounting holes 110 required to fasten the universal mount kit 100 to an intended mounting surface (e.g., the interior of an air duct). In addition, the diameter of mounting holes 110 may be any size required to secure the universal mount kit 100 to the mounting surface.

Still referring to FIGS. 1-2, universal remote mount kit 100 is shown to include a crank arm 134 with a slot 150, and a ball and socket connector 148. In some embodiments, ball and socket connector 148 may be configured to permit free translational movement within slot 150. In other embodiments, ball and socket connector 148 may be fixed at some point within slot 150, depending on the geometry of the connected damper and the mounting orientation of universal remote mount kit 100.

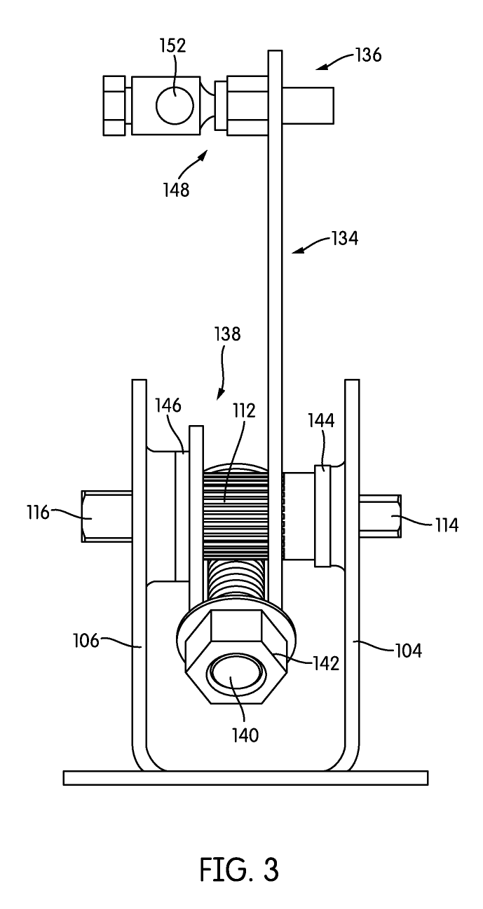

Turning now to FIG. 3, a side view of the universal remote mount kit 100 is depicted, according to some embodiments. As described above with reference to FIGS. 1-2, universal remote mount kit 100 includes a crank arm 134 that is coupled to the drive shaft 112 and the ball socket connector 148. Drive shaft 112 is shown to include a first drive end 114 and a second drive end 116. First drive end 114 may be configured to protrude through first actuator mounting flange 104, while second drive end 116 may be configured to protrude through second actuator mounting flange 106.

In various embodiments, both first drive end 114 and second drive end 116 have a substantially square shape. Similar to the dimensional variation between the first actuator mounting hole pattern 118 and the second actuator mounting hole pattern 126, first drive end 114 may be smaller than second drive end 116 to accommodate an actuator with an overall smaller mounting interface. For example, in some embodiments, first drive end 114 may be 9 mm square, while second drive end 116 may be 11 mm square. In other embodiments, drive shaft 112 may have a knurled portion between the first drive end 114 and the second drive end 116 that increases friction between drive shaft 112, crank arm 134, and coupling bolt 140, described in further detail below.

Crank arm 134 is shown to include a socket connector end 136 and a U-shaped end 138. Socket connector end 136 is configured to couple to the ball and socket connector 148. In some embodiments, ball and socket connector 148 includes a hole 152 for receiving a damper shaft or any other type of damper connection. U-shaped end 138 is configured to couple to the drive shaft 112. Coupling bolt 140 may be configured to retain the U-shaped end 138 of the crank arm 134 on the drive shaft 112. In various embodiments, coupling bolt 140 may be a carriage-style bolt secured by a flange nut 142, although any suitable type of fastener (e.g., bolt, threaded stud) and securing mechanism (e.g., hex nut, lock nut, wing nut) may be utilized to couple the drive shaft 112 to the crank arm 134.

Universal remote mount kit 100 is further shown to include a first bearing 144 and a second bearing 146. Bearings 144-146 may be located proximate to drive shaft 112 to minimize wear caused by the rotation of drive shaft 112 and crank arm 134 on the bearing surfaces of mounting bracket 102. In various embodiments, first bearing 144 may be located between first actuator mounting flange 104 and the U-shaped end 138 of the crank arm 134. Second bearing 146 may be located between second actuator mounting flange 106 and the U-shaped end 138 of the crank arm 134. Bearings 144-146 may be fabricated from any suitable material (e.g., stainless steel, chrome steel) that minimizes wear to mounting bracket 102.

Still referring to FIGS. 1-3, universal remote mount kit 100 may be formed or constructed from a variety of materials and in a variety of manners. For example and in one embodiment, mounting bracket 102 may be of unitary construction (i.e., all one piece), where mounting bracket 102 may be molded, extruded, cast, formed/machined, etc. In another embodiment, first actuator mounting flange 104 and second actuator mounting flange 106 may be fabricated as separate components. As such, first actuator mounting flange 104 and second actuator mounting flange 106 may be joined by any suitable manner (e.g., a bonding agent, a fastener). Accordingly, mounting bracket 102 and crank arm 134 may be constructed from any suitable material, including, but not limited to, metal (e.g., steel, stainless steel, aluminum), metal alloys, plastic, composites, and/or any combination thereof.

Referring now to FIG. 4, a perspective view of a universal remote mount assembly 300 is shown, according to some embodiments. Universal remote mount assembly 300 is shown to include the universal remote mount kit 100 and an actuator 200. In various embodiments, actuator 200 may be a linear actuator (e.g., a linear proportional actuator), a non-linear actuator, a spring return actuator, or a non-spring return actuator. In some embodiments, actuator 200 is an M9000 series actuator sold by Johnson Controls, Inc. As described above, actuator 200 may include features (e.g., anti-rotation posts) configured to fit within the first actuator mounting hole pattern 118 or the second actuator mounting hole pattern 126 such that a mounting face of the actuator 200 is flush with the first actuator mounting flange 104 or the second actuator mounting flange 106.

As the actuator 200 drives along its angular range of motion, the drive mechanism of the actuator 200 coupled to the drive shaft 112 causes the drive shaft 112 to rotate, causing a corresponding rotation in coupled components crank arm 134 and ball and socket damper connector 148. In this way, the drive mechanism of the actuator 200 causes movement of the damper coupled to connector 148 between an open position and a closed position. Although FIG. 4 depicts actuator 200 mounted on the first actuator mounting flange 104, if the mounting interface of actuator 200 is compatible with the second actuator mounting hole pattern 126, actuator 200 may be mounted on the second actuator mounting flange 106. If required, due to the geometry of the damper and mounting location, the orientation of crank arm 134 may be reversed (i.e., such that ball and socket connector 148 points toward first actuator mounting flange 104 rather than second actuator mounting flange 106) by removing coupling bolt 140 and flange nut 142, flipping crank arm 134, and replacing coupling bolt 140 and flange nut 142. Similarly, the angular position of crank arm 134 may be modified relative to drive shaft 112 by loosening coupling bolt 140 and flange nut 142, adjusting the position of crank arm 134, and re-fastening coupling bolt 140 and flange nut 142.

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. Other substitutions, modifications, changes, and omissions may be made in the design, operating conditions and arrangement of the exemplary embodiments without departing from the scope of the present disclosure.

What is claimed is:

1. A remote mount kit for a damper in an HVAC system comprising:
a mounting bracket comprising:
a first mounting flange having a first mounting hole pattern comprising a plurality of holes; and
a second mounting flange having a second mounting hole pattern comprising a plurality of holes;
a drive shaft comprising a first drive end and a second drive end, the first drive end and the second drive end configured to couple to an actuator;
a crank shaft; and
a connector configured to couple the crank shaft to the damper;
wherein a dimension between the plurality of holes of the first mounting hole pattern is smaller than a dimension between the plurality of holes of the second mounting hole pattern.

2. The remote mount kit of claim 1, wherein the mounting bracket comprises at least one bracket mounting flange configured to couple the remote mount kit to a mounting surface.

3. The remote mount kit of claim 2, wherein the mounting surface is an interior surface of an air duct.

4. The remote mount kit of claim 1, wherein the connector is a ball and socket connector.

5. The remote mount kit of claim 1, wherein both the first drive end and the second drive end have a substantially square shape.

6. The remote mount kit of claim 5, wherein a width of the first drive end is smaller than a width of the second drive end.

7. The remote mount kit of claim 1, wherein the drive shaft further comprises a knurled portion between the first drive end and the second drive end.

8. The remote mount kit of claim 1, wherein the crank shaft further comprises a slot and wherein the connector is configured to couple to the slot.

9. The remote mount kit of claim 1, wherein the drive shaft is configured to protrude through the first mounting flange and the second mounting flange.

10. A system for coupling an actuator to a damper, the system comprising:
an actuator comprising a drive mechanism;
a damper comprising a damper blade movable between an open position and a closed position; and
a remote mount kit comprising a mounting bracket having a first mounting hole pattern and a second mounting hole pattern, a drive shaft, a crank shaft, and a connector;
wherein the remote mount kit is configured to couple the drive mechanism of the actuator to the damper to drive the damper between the open position and the closed position.

11. The system of claim 10, wherein the drive shaft comprises a first drive end and a second drive end, and wherein at least one of the first end and the second end is configured to couple to the drive mechanism of the actuator.

12. The system of claim 11, wherein both the first drive end and the second drive end have a substantially square shape.

13. The system of claim 12, wherein a width of the first drive end is smaller than a width of the second drive end.

14. The system of claim 11, wherein drive shaft further comprises a knurled portion between the first drive end and the second drive end.

15. The system of claim 10, wherein both the first mounting hole pattern and the second mounting hole pattern have a square shape.

16. The system of claim 15, wherein a width of the first mounting hole pattern is smaller than a width of the second mounting hole pattern.

17. The system of claim 10, wherein the connector is a ball and socket connector.

18. A universal remote mount kit to couple an actuator to a damper in an HVAC system comprising:
a mounting bracket comprising a first actuator mounting flange having a plurality of holes in a first square pattern;
a drive shaft configured to couple to a drive mechanism of an actuator, comprising a first end having a substantially square shape configured to protrude through the first actuator mounting flange;
a crank shaft coupled to the drive shaft and comprising a slot; and
a damper connector configured to couple to the slot of the crank shaft.

19. The universal remote mount kit of claim 18, wherein the mounting bracket further comprises at least one bracket mounting flange configured to couple the universal remote mount kit to an interior surface of an air duct.

20. The universal remote mount kit of claim 18, wherein:
the mounting bracket further comprises a second actuator mounting flange having a plurality of holes in a second square pattern;
the drive shaft further comprises a second end having a substantially square shape configured to protrude through the second actuator mounting flange; and
wherein a width of the first square pattern is smaller than a width of the second square pattern.
